(19) United States
(12) Patent Application Publication
(10) Pub. No.: US 2017/0132559 A1
(43) Pub. Date: May 11, 2017

(54) METHODS AND SYSTEMS FOR LOADING PRODUCTS INTO A CARGO AREA OF A VEHICLE FOR DELIVERY TO A RETAIL SALES FACILITY

(71) Applicant: Wal-Mart Stores, Inc., Bentonville, AR (US)

(72) Inventors: Nicholaus A. Jones, Fayetteville, AR (US); Robert J. Taylor, Rogers, AR (US); Matthew A. Jones, Bentonville, AR (US); Aaron J. Vasgaard, Rogers, AR (US)

(21) Appl. No.: 15/344,161

(22) Filed: Nov. 4, 2016

Related U.S. Application Data
(60) Provisional application No. 62/251,564, filed on Nov. 5, 2015.

(51) Int. Cl. G06Q 10/08

(52) U.S. Cl. CPC G06Q 10/083; G06Q 10/087

(57) ABSTRACT

In some embodiments, methods and systems of loading products into a delivery vehicle at a product distribution facility for delivery to a retail sales facility are described. A computing device at the product distribution facility may receive at least one inventory management factor that is associated with each of products to be loaded into the delivery vehicle. The computing device may then determine, for each of the products to be delivered and based on one or more of the received inventory management factors, a loading location in a cargo area of the delivery vehicle where each of the products to be delivered are to be loaded. The computing device may then generate an output including an indication of the loading location in a cargo area of the delivery vehicle where each of the products to be delivered are to be loaded.

### RELATED APPLICATIONS

This application claims the benefit of U.S. Provisional Application No. 62/251,564, filed Nov. 5, 2015, which is incorporated herein by reference in its entirety.

### TECHNICAL FIELD

This invention relates generally to the delivery of products to retail sales facilities and, in particular, to the loading of products into delivery vehicles for delivery to retail sales facilities.

### BACKGROUND

Retail sales facilities such as large department stores typically receive products by way of delivery via trucks. Delivery trucks are typically loaded with the products to be delivered at a location such as a product distribution center or warehouse. Delivery trucks are typically loaded at a product distribution center or warehouse without regard for how the products will be worked at the receiving retail sales facility. Such inefficient loading of delivery trucks with products results in inefficiency at the receiving retail sales facility in working certain priority or special storage products off the delivery truck and to their intended destination within the retail sales facility (e.g., store shelf, refrigerator, freezer, etc.).

The unloading of delivery trucks generally accounts for a third of the cost of operation of a retail sales facility. Delivery trucks are typically loaded at a product distribution center or warehouse without regard for facilitating the unloading process for the unloading crew at the receiving retail sales facility. When workers at a retail sales facility have to unload products for longer periods of time from a delivery truck because the products are not optimally sorted in the cargo area of the delivery truck for unloading at the retail sales facility, such inefficiency resulting from non-optimal loading of products into the delivery trucks causes the retail sales facility to incur significant extra operation costs associated with product unload.

### BRIEF DESCRIPTION OF THE DRAWINGS

Disclosed herein are embodiments of systems, apparatuses and methods pertaining to methods and systems for loading products into a delivery vehicle. This description includes drawings, wherein:

FIG. 1 is a diagram of a system for loading products into a cargo area of a delivery truck for delivery to a retail sales facility in accordance with some embodiments.

FIG. 2 is a functional diagram of an electronic inventory management device in accordance with several embodiments.

FIG. 3 is a flow diagram of a process of loading products into a delivery truck for delivery to a retail sales facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, this application describes systems and methods of loading products into a cargo area of a vehicle for delivery to one or more retail sales facilities. The products are loaded based on one or more inventory management factors received from the retail sales facility, such that the product requirements of the retail sales facility are accounted for when determining how to load the cargo area of a delivery truck destined for that retail sales facility.

In one embodiment, a method of loading products into a delivery vehicle at a product distribution facility for delivery to a retail sales facility includes: receiving, by a computing device including a processor at the product distribution facility, at least one inventory management factor that is associated with each of products to be loaded into the delivery vehicle and delivered to the retail sales facility, wherein the at least one inventory management factor comprises at least one of: a size of each of the products, a product category of each of the products, a department at the retail sales facility associated with each of the products, a sales velocity of each of the products at the retail sales facility, and a demand for each of the products at the retail sales facility; determining, using the computing device, for each of the products to be delivered to the retail sales facility and based on the at least one inventory management factor, a loading location in a cargo area of the delivery vehicle where each of the products to be delivered to the retail sales facility are to be loaded; and generating, using the computing device, an output including an indication of the loading location in a cargo area of the delivery vehicle where each of the products to be delivered to the retail sales facility are to be loaded.

In another embodiment, a system of loading products into a delivery vehicle at a product distribution facility for delivery to a retail sales facility includes an electronic inventory management device at the retail sales facility and a computing device including a control unit having a processor in communication with the electronic inventory management device. The control unit is configured to: receive at least one inventory management factor at least one inventory management factor that is associated with each of products to be loaded into the delivery vehicle and delivered to the retail sales facility, wherein the at least one inventory management factor comprises at least one of: a size of each of the products, a product category of each of the products, a department at the retail sales facility associated with each of the products, a sales velocity of each of the products at the retail sales facility, and a demand for each of the products at the retail sales facility; determine, for each of the products to be delivered to the retail sales facility and based on the at least one inventory management factor received from the retail sales facility, a loading location in a cargo area of the delivery vehicle where each of the products to be delivered to the retail sales facility are to be loaded; and generate an output including an indication of the loading location in a cargo area of the delivery vehicle where each of the products to be delivered to the retail sales facility are to be loaded.

In yet another embodiment, a system of loading products into a delivery vehicle at a product distribution facility for delivery to a retail sales facility includes: means for receiving at the product distribution facility, at least one inventory management factor that is associated with each of products to be loaded into the delivery vehicle and delivered to the retail sales facility, wherein the at least inventory management factor comprises at least one of: a size of each of the products, a product category of each of the products, a department at the retail sales facility associated with each of the products, a sales velocity of each of the products at the retail sales facility, and a demand for each of the products at the retail sales facility; means for determining, for each of the products to be delivered to the retail sales facility and based on the at least one inventory management factor, a loading location in a cargo area of the delivery vehicle where each of the products to be delivered to the retail sales facility are to be loaded; and means for generating an output including an indication of the loading location in a cargo area of the delivery vehicle where each of the products to be delivered to the retail sales facility are to be loaded.

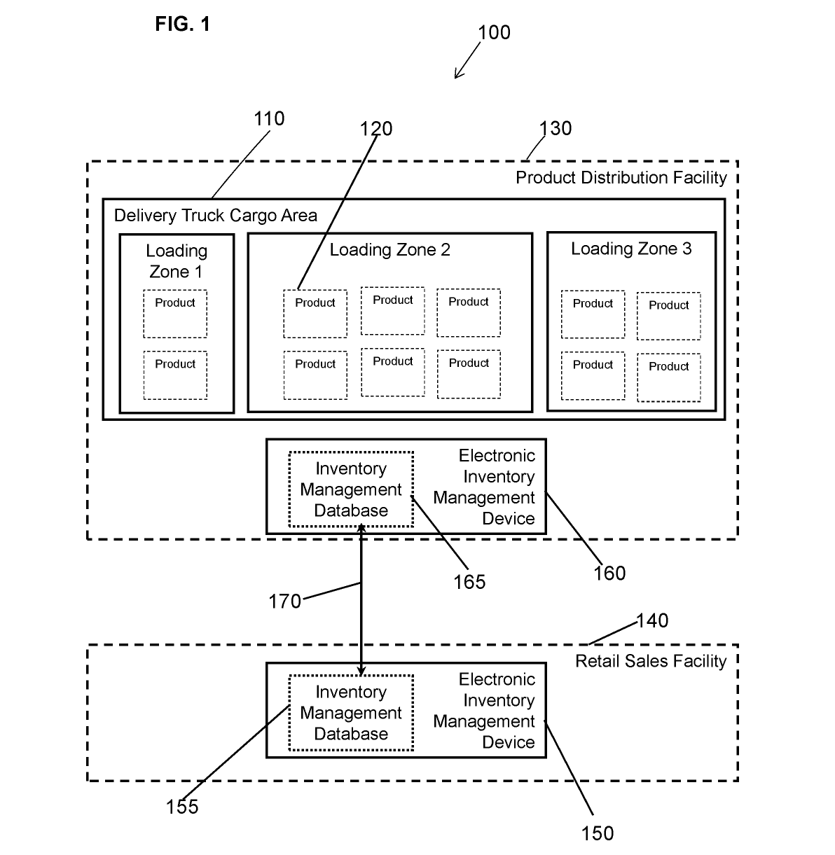

FIG. 1 shows one exemplary embodiment of a system 100 for loading products 120 into a cargo area 110 of a delivery truck for delivery from a product distribution facility 130 to a retail sales facility 140. The retail sales facility 140 may be any place of business such as a store or warehouse where consumer products 120 are stocked and/or sold. While only one retail sales facility 140 is shown in FIG. 1, it will be appreciated that the cargo area 110 of the delivery truck may contain products 120 destined for multiple retail sales facilities 140.

The exemplary system 100 of FIG. 1 includes two electronic inventory management devices 150, 160, which together provide for efficient loading of products 120 into the cargo area 110 of the delivery truck. The electronic inventory management devices 150, 160 illustrated in FIG. 1 may be stationary or portable electronic devices including a processor-based control unit, for example, a desktop computer, a laptop computer, a tablet, a mobile phone, or any other electronic device configured for data entry and one-way and/or two-way communication with each other or a location remote to the product distribution facility 130 and/or the retail sales facility 140 (e.g., a regional server configured for two-way communication with multiple product distribution facilities 130). In the exemplary embodiment of FIG. 1, the electronic inventory management devices 150 and 160 may communicate with one another via a two-way communication channel 170, which may be in the form of a wired or wireless connection.

The exemplary electronic inventory management device 150 of FIG. 1 includes an inventory management database 155 configured to receive and store electronic information regarding the products 120 previously delivered to the retail sales facility 140 and/or in queue to be loaded into the cargo area 110 of a delivery truck for delivery to the retail sales facility 140. The inventory management database 155 may be stored, for example, on non-volatile storage media (e.g., a hard drive, flash drive, or removable optical disk) internal or external relative to the electronic inventory management device 150, or internal or external to computing devices (e.g., remote server) separate from the electronic inventory management device 155. It will be appreciated that the inventory management databases 155 and 165 do not have to be incorporated into their respective electronic inventory management devices 150 and 160, but may be stored on one or more servers remote to the retail sales facility 140 and the product distribution facility 130 and in communication with the electronic inventory management devices 150 and 160.

In some embodiments, the inventory management database 155 may store electronic data representing one or more inventory management factors associated with the products 120 at the retail sales facility 140. Such inventory management factors may include but are not limited to a size of each of the products 120, a product category of each of the products 120, a department at the retail sales facility associated with each of the products 120, a sales velocity of each of the products 120 at the retail sales facility 140, and a demand for each of the products 120 at the retail sales facility 140. The inventory management factors electronically stored in the inventory management database 155 may be received by the electronic inventory management device 150, for example, as a result of a worker at the retail sales facility 140 scanning the products 120 via a hand-held scanner, or as a result of the worker manually entering such data into the electronic inventory management device 150. In some embodiments, at least some of the inventory management factors may be transmitted to the inventory management database 155 from a server (e.g., product manufacturer server) remote to the retail sales facility 140.

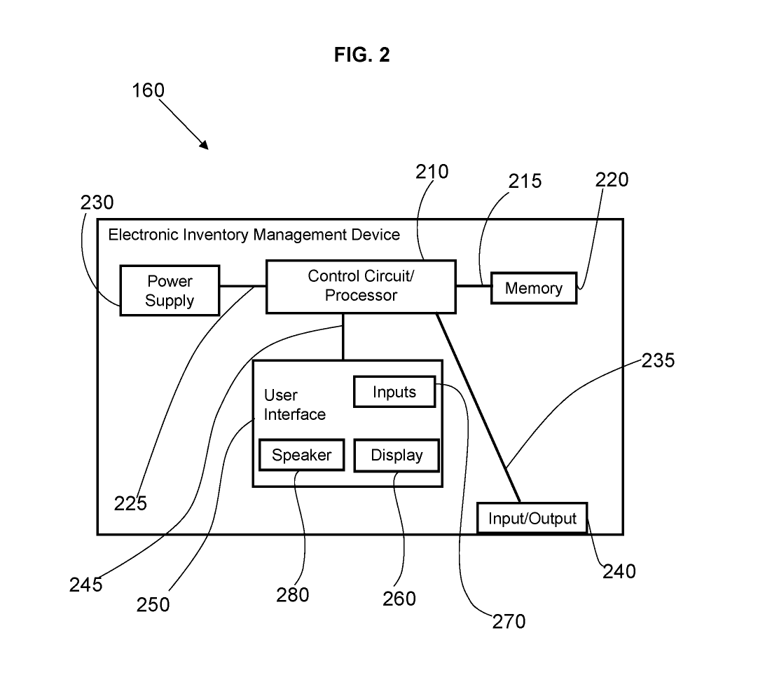

In the exemplary embodiment of FIG. 1, the electronic inventory management devices 150 and 160 are shown as being identical, but it will be appreciated that the electronic inventory management devices 150 and 160 may be different electronic devices (e.g., desktop computers, laptops, electronic tablets, mobile phones, or the like). The exemplary electronic inventory management device 160 depicted in FIG. 2 is a computer-based device and includes a control circuit or unit 210 including a processor (for example, a microprocessor or a microcontroller) electrically coupled via a connection 215 to a memory 220 and via a connection 225 to a power supply 230. The control circuit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description.

The inventory management device 160 shown in FIG. 2 includes a processor-based control unit 210 configured to determine, based on the at least one inventory management factor, a loading location for each of the products 120 in the cargo area 110 of the delivery vehicle where the products 120 designated for delivery to the retail sales facility 140 are to be loaded. In some embodiments, the control unit 210 of the electronic inventory management device 150 is programmed to generate an output (e.g., visual or auditory) including an indication for a worker at a product distribution facility 130 of the determined loading location and/or order for each of the products 120 to be delivered to the retail sales facility 140 in the cargo area 110 of the delivery vehicle. For example, in some embodiments, a worker at the product distribution facility 130 who loads the products 120 (e.g., as caches, cases, and/or pallets) onto a product distribution conveyor that delivers the products 120 to the loading area (i.e., into the delivery truck) is presented with a visual display indicating the order in which the products 120 are to be loaded onto the product distribution conveyor such that the products 120 arrive on the product distribution conveyor to loading area in an order corresponding to the order in which the products 120 are to be loaded into the cargo area 110 of the delivery truck, thereby permitting the worker at the loading area to take the products 120 off the product distribution conveyor in the correct order for loading into the cargo area 110. This control circuit 210 can be configured (for example, by using corresponding programming stored in the memory 220 as will be well understood by those skilled in the art) to carry out one or more of the steps, actions, and/or functions described herein. In some embodiments, the memory 220 may be integral to the control circuit 210 or can be physically discrete (in whole or in part) from the control circuit 210 and is configured non-transitorily store the computer instructions that, when executed by the control circuit 210, cause the control circuit 210 to behave as described herein.

As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM)). Accordingly, the memory and/or the control circuit may be referred to as a non-transitory medium or non-transitory computer readable medium. The control circuit 210 of the electronic inventory management device 160 is also electrically coupled via a connection 235 to an input/output 240 that can receive signals from and send signals (via a wired or wireless connection) to (e.g., commands, inventory database information), for example, devices local to the retail sales facility 140, or one or more servers remote to the retail sales facility 140.

In the embodiment shown in FIG. 2, the processor-based control unit 210 of the electronic inventory management device 160 is electrically coupled via a connection 245 to a user interface 250, which may include a visual display or display screen 260 (e.g., LED screen) and/or button input 270 that provide the user interface 250 with the ability to permit a user such as a stock room or sales floor associate at the retail sales facility 140 to manually control the electronic inventory management device 160 by inputting commands, for example, via touch-screen and/or button operation or voice commands. The display screen 260 can also permit the user to see various menus, options, and/or alerts displayed by the electronic inventory management device 160. The user interface 250 of the electronic inventory management device 160 may also include a speaker 280 that may provide audible feedback (e.g., alerts) to the user.

With reference to FIGS. 1-3, one method 300 of operation of the system 100 in order to load products 120 into a cargo area 110 of a delivery truck at a product distribution facility 120 will now be described. For exemplary purposes, the method 300 is described in the context of the system 100 of FIG. 1, but it is understood that embodiments of the method 300 may be implemented in the system 100 or other systems.

In some embodiments, before a cargo area 110 of a delivery truck is loaded with products 120 for delivery to the retail sales facility 140, a list of products 120 to be delivered from the product distribution facility 130 to the retail sales facility 140 may be generated by the control unit 120 of the electronic inventory management device 160 at the product distribution facility 130, or by the electronic inventory management device 150 at the retail sales facility 140 and transmitted via the wired or wireless signal 170 to the electronic inventory management device 160. The list of products 120 to be delivered to the retail sales facility 140, once generated, may be temporarily or permanently stored in the inventory management databases 155 and/or 165 of the electronic inventory management devices 150 and 160, respectively.

Once a list of products 120 to be delivered to the retail sales facility 140 from the product distribution facility 130 is generated as discussed above, the electronic inventory management device 150 may transmit (e.g., via the communication channel 170) to the electronic inventory management device 160 one or more inventory management factor that is associated with each of products 120 on the list of products to be loaded into the cargo area 110 of the delivery vehicle at the product distribution facility 130 and delivered to the retail sales facility 140 (step 310). It will be appreciated that one or more inventory management factors may be transmitted to the electronic inventory management device 160 located at the product distribution facility 130 directly from the electronic inventory management device 150 located at the retail sales facility 140 (e.g., via communication channel 170), or may be transmitted to the electronic inventory management device 160 located at the product distribution facility 130 via an intermediate server remote to both the product distribution facility 130 and the retail sales facility 140.

The inventory management factors that may be transmitted to the electronic inventory management device 160 from the electronic inventory management device 150 may include various attributes of a product 120, including but not limited to: size of the product 120 (e.g., length, width, height), category of the product 120 (video game, board game, etc.); department or zone (e.g., “Toys,” “Beauty Aids,” aisle number) at the retail sales facility 140 where the product 120 will be stocked; and sales velocity of/demand for the product 120 (units of product 120 predicted to be sold and/or actually sold within a predetermined period of time, e.g., 24 hours, one week, one month) at the retail sales facility 140.

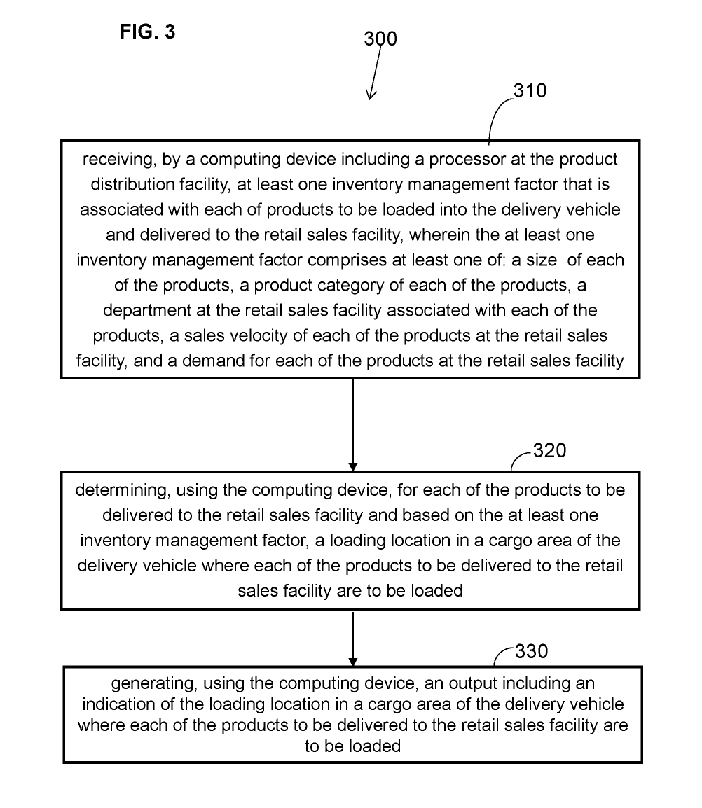

In the exemplary method 300 illustrated in FIG. 3, the control circuit 210 of the electronic inventory management device 150 is programmed to determine, based on at least one of the above-discussed inventory management factors, a loading location for each of the products 120 in the cargo area 110 of the delivery vehicle where each of the products 120 to be delivered to the retail sales facility 140 are to be loaded (step 320). As shown in FIG. 3, after the loading location for each of the products 120 in the cargo area 110 of the delivery vehicle is generated by the control unit 210 of the electronic inventory management device, the control unit 210 of the electronic inventory management device 160 is programmed to generate an output including an indication of the loading location in the cargo area 110 of the delivery vehicle where each of the products 120 to be delivered to the retail sales facility 140 are determined to be loaded (step 330). Such an output may be generated for a worker at the product distribution facility 130 on the visual display 260 of the electronic inventory management device 160, or via the speaker 280 of the electronic inventory management device 160. In some embodiments, the output may be a step-by-step list of instructions for loading the products 120 into the cargo area 110 of the delivery vehicle.

In some embodiments, the processor of the control circuit 210 of the electronic inventory management device 160 is programmed to generate the output indicated where in the cargo area 110 of the delivery truck the products 120 are to be loaded based on one or more of the inventory management factors received from the electronic inventory management device 150. More specifically, the processor of the control circuit 210 of the exemplary electronic inventory management device 160 of FIGS. 1 and 2 is programmed to group products 120 having at least one inventory management factor in common near one another (i.e., together) in the cargo area 110 of the delivery truck.

In the embodiment of in FIG. 1, the control circuit 210 of the electronic inventory management device 160 is programmed to categorize the cargo area 110 of the delivery truck into three loading locations or zones, namely: Zone 1 at or near the front of the cargo area 110, Zone 2 at or near the rear of the cargo area 110, and Zone 2 at or near the middle of the cargo area 110 and between Zones 1 and 3. Zone 1 of the cargo area 110 is generally designated for priority products that can be immediately worked to the sales floor of the retail sales facility 140 immediately upon unload from the delivery truck; Zone 2 is generally designated for traditional replenishment products to be worked to a shelf on the sales floor during the overnight stock; and Zone 3 is generally designated for products that are not expected to be worked to the shelf right away, such as direct-to-bin products, or products to be featured or released at a later date. It will be appreciated that in some embodiments, the cargo area 110 of the delivery truck may be sub-divided into less than three zones (e.g., two zones), or may be sub-divided into more than three zones (e.g., four, five, six zones, or more), where appropriate for the products 120 being loaded into the cargo area 110. It will also be appreciated that in some embodiments, one or more of loading zones 1, 2, and 3 may be sub-divided into one or more sub-zones (e.g., sub-zones for products 190 sharing a product category and/or a department at the retail sales facility 140).

The inventory management factor pertaining to a physical size of the product 120 may be a consideration in some embodiments in determining how to load up the cargo area 110 of the delivery truck. In some embodiments, the control unit 210 of the electronic management device 160 is programmed to generate an output indicating that smaller-sized products 120 that are to be loaded into the cargo area 110 of the delivery truck are to be loaded in zone 3 at or near the back of the cargo area 110. Since smaller-sized products 120 are easier to unload from the cargo area 110 of the delivery truck than lager-sized products 120, arranging the smaller-sized products 120 at the back of the cargo area 110 of the delivery truck facilitates a quicker unload of the smaller products 120. In some embodiments where the products 120 to be delivered to a retail sales facility 140 are to be delivered on pallets, the control unit 210 of the electronic management device 160 is programmed to generate an output indicating that the pallets are to be located in zone 1 (at the front of the cargo area 110) or in zone 3 (at the back of the cargo area) to ensure limited leverage of pallet jack during the unloading of the products 120 and to ensure that the boxes of products in the middle zone 2 stay in place.

The inventory management factor pertaining to a category of the product 120 (“Vitamins,” “Lipstick,” “Video Games,” etc.) may also be a consideration in some embodiments in determining how to load up the cargo area 110 of the delivery truck. In some embodiments, upon receiving an indication that two or more of the products 120 to be loaded into the cargo area 110 for delivery to the retail sales facility 140 are of the same category, the processor of the control circuit 210 of the electronic inventory management device 160 is programmed to group such products 120 together (i.e., near one another) in the cargo area 110 of the delivery truck.

In some embodiments, the inventory management factor pertaining to a department (“Health Supplements,” “Beauty Products,” “Toys”) or physical location (Aisle No. 10) associated with the product 120 at the retail sales facility 140 may be a consideration in determining how to load up the cargo area 110 of the delivery truck. In some embodiments, upon receiving an indication that two or more of the products 120 to be loaded into the cargo area 110 for delivery to the retail sales facility 140 are to be stocked in the same department or on a shelf in the same aisle of the sales floor, the processor of the control circuit 210 of the electronic inventory management device 160 is programmed to group products 120 having the common department or physical location at the retail sales facility 140 together (i.e., near one another) in the cargo area 110 of the delivery truck.

The inventory management factor pertaining to a sales velocity of the product 120 (i.e., how many units of the product are predicted to be sold at the retail sales facility 140 over a predetermined period of time) may also be a consideration in determining how to load up the cargo area 110 of the delivery truck. In some embodiments, upon receiving an indication that a product 120 is a high velocity product (i.e., is predicted to sell fast at the retail sales facility 140), the processor of the control circuit 210 of the electronic inventory management device 160 can be programmed to designate the high velocity product 120 for loading into zone 3 of the cargo area 110 of the delivery truck so that such high velocity product 120 may be quickly unloaded from the delivery truck and quickly taken to the sales floor of the retail sales facility 140 for faster access by the consumers.

The inventory management factor pertaining to the consumer demand for the product 120 (i.e., how many units of the product were actually sold at the retail sales facility 140 over a predetermined period of time) may also be a consideration in determining how to load up the cargo area 110 of the delivery truck. In some embodiments, upon receiving an indication that a product 120 is in high demand by the consumers (i.e., more units of this product 120 were sold over the past day or week at the retail sales facility 140 as compared to similar products), the processor of the control circuit 210 of the electronic inventory management device 160 is programmed to generate an output designating the high velocity products 120 for loading into zone 3 of the cargo area 110 of the delivery truck, such that such high demand products 120 may be quickly unloaded from the delivery truck and quickly taken to the sales floor of the retail sales facility 140 for faster access by the consumers.

The inventory management factor pertaining to high-priority products (e.g., out-of-stock products) may also be a consideration in determining how to load up the cargo area 110 of the delivery truck. In some embodiments, upon receiving an indication that a product 120 is presently out-of-stock at the retail sales facility 140, the processor of the control circuit 210 of the electronic inventory management device 160 is programmed to generate an output designating the out-of-stock product for loading into zone 3 of the cargo area 110 of the delivery truck, so that the out-of-stock product 120 may be quickly unloaded from the delivery truck when delivered to the retail sales facility 140, and quickly taken to the sales floor of the retail sales facility 140 for faster access by the consumers. In some embodiments, upon receiving an indication that a product 120 is present in the most baskets at the retail sales facility 140, the processor of the control circuit 210 of the electronic inventory management device 160 is programmed to designate the product that is in the most baskets for loading into zone 3 of the cargo area 110 of the delivery truck, so that such a product 120 may be quickly unloaded from the cargo area 110 of the truck when delivered to the retail sales facility 140, and quickly taken to the sales floor of the retail sales facility 140 for faster access by the consumers.

In some embodiments, inventory management factor pertaining to low-priority products may also be a consideration in determining how to load up the cargo area 110 of the delivery truck. Direct-to-bin products are an example of low priority products and will be understood as products that are known to not fit on the sales floor of the retail sales facility 140, and which will be binned in the stock room of the retail sales facility 140 after delivery. In some embodiments, upon receiving an indication that a product 120 is a low priority direct-to-bin product, the processor of the control circuit 210 of the electronic inventory management device 160 is programmed to designate the direct-to-bin product for loading into zone 1 near the front of the cargo area 110 of the delivery truck. Thus, the direct-to-bin product 120 may be unloaded from the delivery truck last when delivered to the retail sales facility 140, since there is no urgency to quickly deliver this product 120 to the sales floor. In some embodiments, upon receiving an indication that one or more of the products 120 to be loaded into the cargo area 110 for delivery to the retail sales facility 140 are direct-to-bin products that will go into the same bin in the stock room of the retail sales facility 140, the processor of the control circuit 210 of the electronic inventory management device 160 is programmed to group the direct-to-bin products 120 having a common storage bin destination together in the cargo area 110 of the delivery truck.

The inventory management factor pertaining to medium-priority products (e.g., standard replenishment products) may also be a consideration in determining how to load up the cargo area 110 of the delivery truck. In some embodiments, upon receiving an indication that a product 120 has medium priority in that it is a standard replenishment product, the processor of the control circuit 210 of the electronic inventory management device 160 is programmed to designate the standard replenishment product for loading into zone 2 near the middle of the cargo area 110 of the delivery truck, such that the standard replenishment product 120 may be unloaded from the delivery truck after the high priority products 120 are unloaded, but before the low priority direct-to-bin products 120 are unloaded.

The inventory management factor pertaining to unloading crew availability at the retail sales facility 140 may also be a consideration in determining how to load up the cargo area 110 of the delivery truck. In some embodiments, upon receiving an indication that the unloading crew at the retail sales facility 140 is at full capacity, the processor of the control circuit 210 of the electronic inventory management device 160 is programmed to generate a full load of products 120 into the cargo area 110 of the delivery truck to be delivered to the retail sales facility 140.

Conversely, the electronic inventory management device 160 may receive an indication from the electronic inventory management device 150 that the unloading crew capacity is low, or that the unloading crew is not available at the retail sales facility 140 during a window of time when the delivery vehicle is expected to arrive at the retail sales facility 140. In such cases, the processor of the control circuit 210 of the electronic inventory management device 160 can be programmed to restrict at least some of the products 120 on the list of products 120 to be delivered to the retail sales facility 140 from being loaded into the cargo area 110 of the delivery truck, thereby reducing the number of products 120 that will be delivered to the retail sales facility 140, such that the lower capacity unloading crew can handle the reduced number of products 120.

In one exemplary embodiment, based on an analysis of the inventory management factors (e.g., size of each product 120, product category of each product 120, department associated with each product 120, sales velocity of each product 120, demand for each product 120, etc.) obtained from the inventory management database 155, the control circuit 210 of the electronic inventory management device 160 is programmed to identify products 120 that would not fit within the space available on the sales floor of the destination retail sales facility 140, generate an output classifying such products 120 as low priority products, and generate an output instructing placement of such products 120 in the deepest part (i.e., loading zone 1) of the cargo area 110. In some embodiments, the control circuit 210 of the electronic inventory management device 160 is programmed to classify products 120 that do not yet have a home location on the sales floor of the retail sales facility 140 and are likely going directly into reserve (e.g., stock room) as low priority products, and generate an output instructing placement of such products 120 in the deepest part (i.e., loading zone 1) of the cargo area 110.

In some aspects, based on an analysis of the inventory management factors obtained from the inventory management database 155, the control circuit 210 of the electronic inventory management device 160 is programmed to identify products 120 for which there is space available on the sales floor, but which are designated for stocking, not for placement on the sales floor. The control circuit 210 of the electronic inventory management device 160 is programmed to sort such products 120 by their inventory management factors such as size, location, and ease of unload (which factors are determined by the control circuit 210 over time based on different load patterns). In some embodiments, the control circuit 210 of the electronic inventory management device 160 after identifying certain products 120 as priority items (e.g., items currently out of stock at the destination retail sales facility 140) based on an analysis of applicable inventory management factors, is programmed to generate an output instructing placement of such products in the closest (first to unload) part (i.e., loading zone 3) of the cargo area 110. Generally, the control circuit 210 of the electronic inventory management device 160 is programmed to set a set of rules for each segment of the cargo area 110 of the delivery truck based on an analysis of all applicable inventory management factors described above including but not limited to current selling pattern of products 120, information obtained from inventory management database 155 of the retail sales facility 140, lead time, transit time, unload effort, optimized truck load balancing, and sales floor availability.

The systems and methods described herein provide for efficient loading of products into cargo areas of trucks for delivery to retail sales facilities. Such loading of products into the delivery trucks advantageously provides for more efficient retrieval of the products from the delivery trucks when the products are delivered to the retail sales facilities. Accordingly, the systems and methods described herein advantageously facilitate the unloading of products at retail sales facilities and thereby provide for significant cost savings to the retail sales facilities.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A method of loading products into a delivery vehicle at a product distribution facility for delivery to a retail sales facility, the method comprising:
receiving, by a computing device including a processor at the product distribution facility, at least one inventory management factor that is associated with each of products to be loaded into the delivery vehicle and delivered to the retail sales facility, wherein the at least one inventory management factor comprises at least one of: a size of each of the products, a product category of each of the products, a department at the retail sales facility associated with each of the products, a sales velocity of each of the products at the retail sales facility, and a demand for each of the products at the retail sales facility;
determining, using the computing device, for each of the products to be delivered to the retail sales facility and based on the at least one inventory management factor, a loading location in a cargo area of the delivery vehicle where each of the products to be delivered to the retail sales facility are to be loaded; and
generating, using the computing device, an output including an indication of the loading location in a cargo area of the delivery vehicle where each of the products to be delivered to the retail sales facility are to be loaded.

2. The method of claim 1, wherein the receiving step further includes one of:
receiving the at least one inventory management factor at the computing device, located at the product distribution facility, directly from an electronic inventory management device located at the retail sales facility; and
receiving the at least one inventory management factor at the computing device, located at the product distribution facility, from an electronic inventory management device located at the retail sales facility, via an intermediate server remote to both the retail sales facility and the product distribution facility.

3. The method of claim 1, wherein the receiving step further includes receiving, by the computing device, an indication that at least two of the products to be delivered to the retail sales facility have at least one inventory management factor in common, and wherein the determining step further includes determining, by the computing device, that the at least two of the products having the at least one inventory management factor in common are to be loaded into a common loading location in the cargo area of the delivery vehicle.

4. The method of claim 3, wherein the receiving step further includes receiving, by the computing device, an indication from an electronic inventory management device at the retail sales facility that the at least two of the products to be delivered to the retail sales facility share an aisle on a sales floor at the retail sales facility, and wherein the determining step further includes determining, by the computing device, that the at least two products sharing the aisle on the sales floor at the retail sales facility are to be loaded into a common loading location in the cargo area of the delivery vehicle.

5. The method of claim 1, wherein the determining step further comprises designating, using the computing device, at least three loading locations for the cargo area of the delivery vehicle, wherein the at least three loading locations are front of the cargo area, middle of the cargo area, and back of the cargo area.

6. The method of claim 5, wherein the receiving step further includes receiving, by the computing device, an indication from an electronic inventory management device at the retail sales facility that at least one of the products to be delivered to the retail sales facility is presently out of stock at the retail sales facility, and wherein the determining step further includes determining, by the computing device, that the at least one out of stock product is to be loaded at the back of the cargo area of the delivery vehicle.

7. The method of claim 5, wherein the receiving step further includes receiving, by the computing device, an indication from the electronic inventory management device at the retail sales facility that at least one of the products to be delivered to the retail sales facility is a direct-to-bin product, and wherein the determining step further includes determining, by the computing device, that the at least one direct-to-bin product is to be loaded at the front of the cargo area of the delivery vehicle.

8. The method of claim 5, wherein the receiving step further includes receiving, by the computing device, an indication from the electronic inventory management device at the retail sales facility that at least one of the products to be delivered to the retail sales facility is a standard replenishment product, and wherein the determining step further includes determining, by the computing device, that the at least one standard replenishment product is to be loaded at the middle of the cargo area of the delivery vehicle.

9. The method of claim 1, wherein the receiving step further includes receiving, by the computing device, an indication from the electronic inventory management device at the retail sales facility of unloading crew capacity at the retail sales facility during a window of time when the delivery vehicle is expected to arrive at the retail sales facility, and wherein the determining step further includes restricting, by the computing device, delivery of at least some of the products to be delivered to the retail sales facility based on the received unloading crew capacity.

10. The method of claim 9, wherein the receiving step further includes receiving, by the computing device, an indication from the electronic inventory management device at the retail sales facility that at least one of the products to be delivered is presently stored in at least one storage bin at the retail sales facility, and wherein the restricting step further includes, preventing, by the computing device, delivery of the at least one of the products stored in the at least one storage bin at the retail sales facility to the retail sales facility.

11. A system of loading products into a delivery vehicle at a product distribution facility for delivery to a retail sales facility, the system comprising:
an electronic inventory management device at the retail sales facility; and
a computing device including a control unit having a processor in communication with the electronic inventory management device and configured to:
receive at least one inventory management factor at least one inventory management factor that is associated with each of products to be loaded into the delivery vehicle and delivered to the retail sales facility, wherein the at least one inventory management factor comprises at least one of: a size of each of the products, a product category of each of the products, a department at the retail sales facility associated with each of the products, a sales velocity of each of the products at the retail sales facility, and a demand for each of the products at the retail sales facility;
determine, for each of the products to be delivered to the retail sales facility and based on the at least one inventory management factor received from the retail sales facility, a loading location in a cargo area of the delivery vehicle where each of the products to be delivered to the retail sales facility are to be loaded; and
generate an output including an indication of the loading location in a cargo area of the delivery vehicle where each of the products to be delivered to the retail sales facility are to be loaded.

12. The system of claim 11, wherein the computing device is configured to one of: receive the at least one inventory management factor directly from the electronic inventory management device; and receive the at least one inventory management factor from the electronic inventory management device via an intermediate server remote to both the retail sales facility and the product distribution facility.

13. The system of claim 11, wherein the control unit is further configured to, in response to receiving an indication that at least two of the products to be delivered to the retail sales facility have at least one inventory management factor in common, determine that the at least two of the products having the at least one inventory management factor in common are to be loaded into a common loading location in the cargo area of the delivery vehicle.

14. The system of claim 13, wherein the control unit is further configured to, in response to receiving an indication from the electronic inventory management device at the retail sales facility that the at least two of the products to be delivered to the retail sales facility share an aisle on a sales floor at the retail sales facility, determine that the at least two products sharing the aisle on the sales floor at the retail sales facility are to be loaded into a common loading location in the cargo area of the delivery vehicle.

15. The system of claim 11, wherein the control unit is further configured to designate at least three loading locations for the cargo area of the delivery vehicle, wherein the at least three loading locations are front of the cargo area, middle of the cargo area, and back of the cargo area.

16. The system of claim 15, wherein the control unit is further configured to, in response to receiving an indication from the electronic inventory management device at the retail sales facility that at least one of the products to be delivered to the retail sales facility is presently out of stock at the retail sales facility, determine that the at least one out of stock product is to be loaded at the back of the cargo area of the delivery vehicle.

17. The system of claim 15, wherein the control unit is further configured to, in response to receiving an indication from the electronic inventory management device at the retail sales facility that at least one of the products to be delivered to the retail sales facility is a direct-to-bin product, determine that the at least one direct-to-bin product is to be loaded at the front of the cargo area of the delivery vehicle.

18. The system of claim 15, wherein the control unit is further configured to, in response to receiving an indication from the electronic inventory management device at the retail sales facility that at least one of the products to be delivered to the retail sales facility is a standard replenishment product, determine that the at least one standard replenishment product is to be loaded at the middle of the cargo area of the delivery vehicle.

19. The system of claim 11, wherein the control unit is further configured to, in response to receiving an indication from the electronic inventory management device at the retail sales facility of unloading crew capacity at the retail sales facility during a window of time when the delivery vehicle is expected to arrive at the retail sales facility, restrict delivery of at least some of the products to be delivered to the retail sales facility based on the received unloading crew capacity.

20. The system of claim 19, wherein the control unit is further configured to, in response to receiving an indication from the electronic inventory management device at the retail sales facility that at least one of the products to be delivered is presently stored in at least one storage bin at the retail sales facility, prevent delivery of the at least one of the products stored in the at least one storage bin at the retail sales facility to the retail sales facility.

21. A system of loading products into a delivery vehicle at a product distribution facility for delivery to a retail sales facility, the system comprising:
means for receiving at the product distribution facility, at least one inventory management factor that is associated with each of products to be loaded into the delivery vehicle and delivered to the retail sales facility, wherein the at least inventory management factor comprises at least one of: a size of each of the products, a product category of each of the products, a department at the retail sales facility associated with each of the products, a sales velocity of each of the products at the retail sales facility, and a demand for each of the products at the retail sales facility;
means for determining, for each of the products to be delivered to the retail sales facility and based on the at least one inventory management factor, a loading location in a cargo area of the delivery vehicle where each of the products to be delivered to the retail sales facility are to be loaded; and
means for generating an output including an indication of the loading location in a cargo area of the delivery vehicle where each of the products to be delivered to the retail sales facility are to be loaded.
